(19) United States
(12) Patent Application Publication
(10) Pub. No.: US 2025/0063970 A1
(43) Pub. Date: Feb. 27, 2025

(54) TOOL MOUNT FOR ROW UNITS OF AN AGRICULTURAL IMPLEMENT AND RELATED ROW UNITS AND IMPLEMENTS

(71) Applicant: CNH Industrial America LLC, New Holland, PA (US)

(72) Inventors: Brian Michael Craig, Congerville, IL (US); Jeffry Scott Huber, Eureka, IL (US)

(21) Appl. No.: 18/807,326

(22) Filed: Aug. 16, 2024

Related U.S. Application Data
(60) Provisional application No. 63/578,396, filed on Aug. 24, 2023.

(51) Int. Cl. A01B 35/28

(52) U.S. Cl. CPC A01B 35/28

(57) ABSTRACT

A tool mount configured for use with an agricultural implement includes a mounting plate assembly having a mount plate and a mount sleeve. The mount plate is configured to be rigidly coupled to a frame of the implement and defines a depth stop channel. The mount sleeve extends outwardly from the mount plate along a pivot axis. The tool mount also includes an arm assembly configured to support a ground-engaging tool of the implement. The arm assembly includes a mounting arm pivotably coupled to the mount sleeve such that the arm assembly is configured to pivot about the pivot axis across a pivot range. The arm assembly further includes a stop pin extending outwardly from the mounting arm that is configured to be received within the depth stop channel to limit pivoting of the arm assembly relative to the mounting plate assembly.

### CROSS-REFERENCE TO RELATED APPLICATIONS

The present application is based upon and claims the right of priority to U.S. Provisional Patent Application No. 63/578,396, filed Aug. 24, 2023, the disclosure of which is hereby incorporated by reference herein in its entirety for all purposes.

### FIELD OF THE INVENTION

The present subject matter relates generally to agricultural implements, such as strip tillage implements and, more particularly, to a tool mount for a row unit of an agricultural implement that permits a ground-engaging tool to be supported relative to a frame of the row unit and to row units and implements incorporating such tool mounts.

### BACKGROUND OF THE INVENTION

Many agricultural implements include row units for processing a narrow strip of soil during the performance of an agricultural operation. For instance, planters include planter row units for opening a furrow along a narrow strip of soil, depositing a seed within the furrow, and then subsequently closing the furrow. Similarly, strip-tillage implements include strip-tillage row units for tilling a narrow strip of soil to prepare the soil for subsequent planting.

Strip-tillage row units generally include a plurality of ground-engaging tools supported relative to the ground via a row unit frame. For instance, each tool is typically coupled to the row unit frame via an associated mounting assembly. These mounting assemblies can vary significantly in configuration and function. As the industry advances and market demands increase, there is a need for further improvements and advancements in relation to tool mounting configurations for supporting ground-engaging tools on a row unit.

Accordingly, an improved tool mount for a row unit of an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a row unit for an agricultural implement. The row unit includes a row unit frame and a tool mount configured to support a ground-engaging tool of the row unit relative to the row unit frame. The tool mount includes a mounting plate assembly comprising a mount plate and a mount sleeve. The mount plate is configured to be rigidly coupled to the row unit frame and defines a depth stop channel. The mount sleeve extends outwardly from the mount plate along a pivot axis. The tool mount also includes an arm assembly coupled between the mounting plate assembly and the ground-engaging tool. The arm assembly includes a mounting arm pivotably coupled to the mount sleeve such that the arm assembly is configured to pivot relative to the mounting plate assembly about the pivot axis across a pivot range of the arm assembly. The depth stop channel at least partially defines the pivot range for the arm assembly and the arm assembly includes a stop pin extending outwardly from the mounting arm that is configured to be received within the depth stop channel. Additionally, the stop pin is configured to engage at least one end of the depth stop channel to limit further pivoting of the arm assembly relative to the mounting plate assembly.

In another aspect, the present subject matter is directed to an agricultural implement including a frame and a plurality of row units supported relative to the frame. Each row unit includes a row unit frame and a tool mount configured to support a ground-engaging tool of the agricultural implement relative to the row unit frame. The tool mount includes a mounting plate assembly comprising a mount plate and a mount sleeve. The mount plate is configured to be rigidly coupled to the row unit frame and defines a depth stop channel. The mount sleeve extends outwardly from the mount plate along a pivot axis. The tool mount also includes an arm assembly coupled between the mounting plate assembly and the ground-engaging tool. The arm assembly includes a mounting arm pivotably coupled to the mount sleeve such that the arm assembly is configured to pivot relative to the mounting plate assembly about the pivot axis across a pivot range of the arm assembly. The depth stop channel at least partially defines the pivot range for the arm assembly, and the arm assembly includes a stop pin extending outwardly from the mounting arm that is configured to be received within the depth stop channel. Additionally, the stop pin is configured to engage at least one end of the depth stop channel to limit further pivoting of the arm assembly relative to the mounting plate assembly.

In a further aspect, the present subject matter is directed to a tool mount configured for use with an agricultural implement. The tool mount includes a mounting plate assembly comprising a mount plate and a mount sleeve. The mount plate is configured to be rigidly coupled to a frame of the agricultural implement and defines a depth stop channel. The mount sleeve comprises a hardened sleeve welded to the mounting plate to provide a rigid connection between the mount sleeve and the mount plate, with the mount sleeve extending outwardly from the mount plate along a pivot axis. The tool mount also includes an arm assembly configured to support a ground-engaging tool of the agricultural implement relative to the mounting plate assembly. The arm assembly includes a mounting arm pivotably coupled to the mount sleeve such that the arm assembly is configured to pivot relative to the mounting plate assembly about the pivot axis across a pivot range of the arm assembly. The depth stop channel at least partially defines the pivot range for the arm assembly, and the arm assembly includes a stop pin extending outwardly from the mounting arm that is configured to be received within the depth stop channel. Additionally, the stop pin is configured to engage at least one end of the depth stop channel to limit further pivoting of the arm assembly relative to the mounting plate assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of one embodiment of a tool mount suitable for use with a row unit of an agricultural implement in accordance with aspects of the present subject matter, particularly illustrating the tool mount installed relative to a row unit frame of a row unit and further illustrating a zoomed-in portion of the tool mount shown within box AA-AA;

FIG. 4 illustrates a perspective, partially exploded view of the tool mount and row unit frame shown in FIG. 3;

FIG. 5 illustrates a perspective view of a mounting plate assembly of the tool mount as installed relative to the row unit frame;

FIG. 6 illustrates a perspective, assembled view of the mounting plate assembly shown in FIG. 5 with the various fasteners removed for purposes of illustration; and

FIG. 7 illustrates a perspective, exploded view of the mounting plate assembly shown in FIG. 6.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an improved tool mount for a row unit of an agricultural implement. As will be described below, the disclosed tool mount generally includes a mounting plate assembly and an arm assembly. The mounting plate assembly is generally configured to be rigidly coupled to a frame of the row unit and incorporates features for pivotably coupling the arm assembly to the mounting plate assembly and for limiting a pivot range of the arm assembly relative thereto. The arm assembly includes one or more arms coupled between the mounting plate assembly and an associated ground-engaging tool of the row unit to allow the tool to be supported relative to the row unit frame. Various functions and advantages of the disclosed tool mount will generally be described below with reference to the figures.

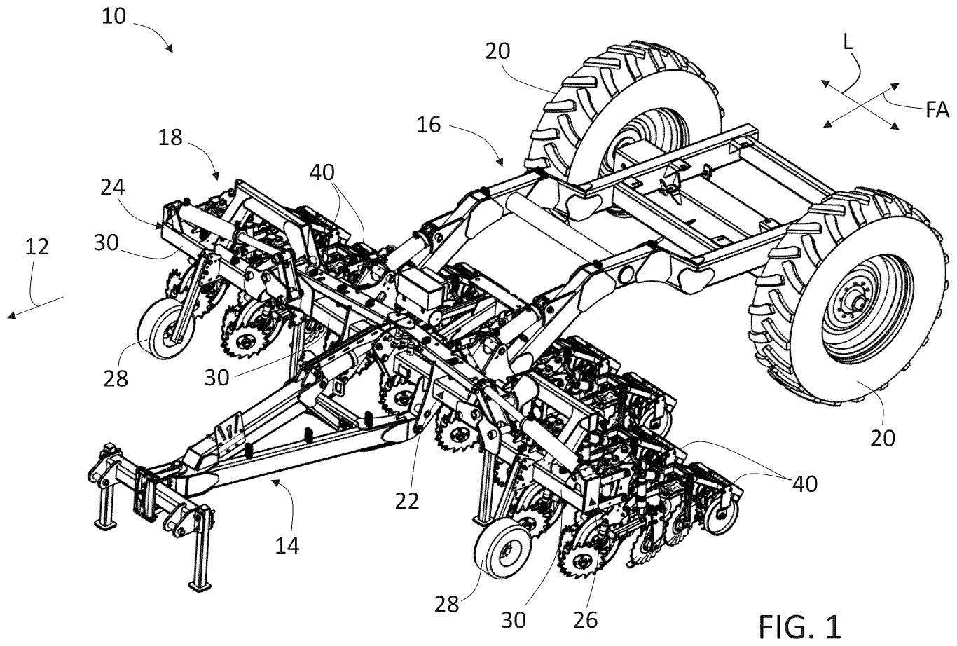

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

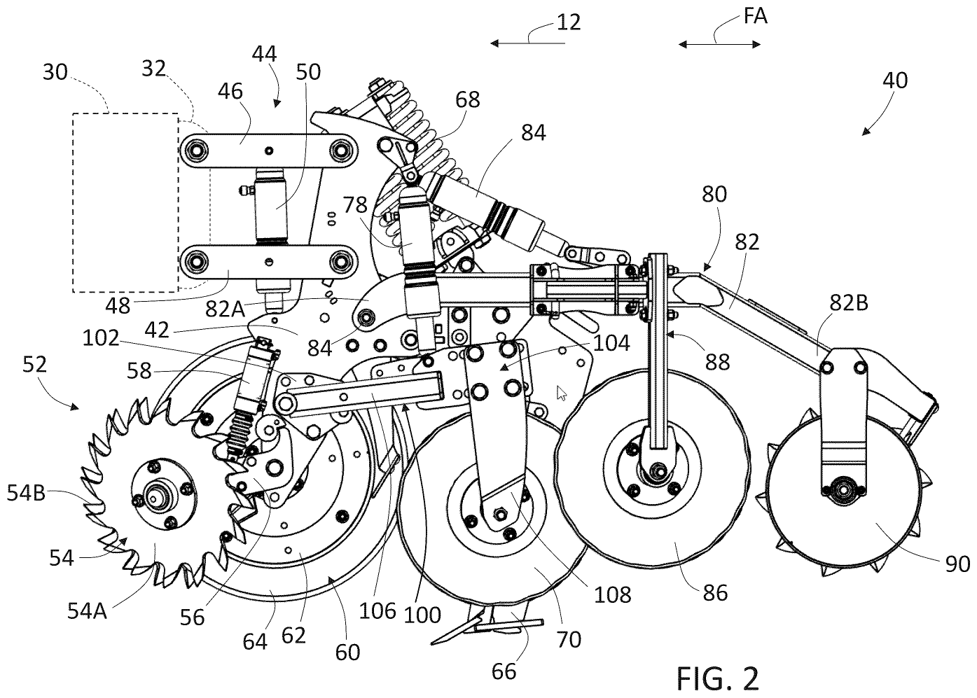

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (e.g., a first row cleaner disc 54A and a second row cleaner disc 54B), with each disc 54 being pivotably coupled to the main frame via a row cleaner arm 56. As is generally understood, the row cleaner discs 54 may be toothed or spiked, such as by including a plurality of fingers or teeth) extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes one or more row cleaner actuators 58 configured to provide a downward biasing force against the row cleaner 52, with the row cleaner actuator 58 being coupled between the main frame 42 and the row cleaner arm 56. In one embodiment, the row cleaner actuator(s) 58 may be passive actuators, such as air shocks or springs. Alternatively, the row cleaner actuator(s) 58 may be actively controlled actuators, such as pneumatic or hydraulic cylinders.

Moreover, as shown in FIG. 2, the row unit 40 may also include a center coulter 60 positioned generally adjacent the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, as will be described below, the relative positioning between the row cleaner discs 54 and the center coulter 60 may allow such component to efficiently and effectively process residue in the path of the row unit 40. Specifically, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a side coulter mount or generally a “tool mount” 100. As will be described below, the tool mount 100 generally includes a mounting plate assembly 102 and an arm assembly 104 including a mounting arm 106 and a support arm 108, with the mounting arm 106 being pivotably coupled to the main frame 42 at one end via the mounting plate assembly 102 and being coupled to the support arm 108 at the other end. The support arm 108 may, in turn, be coupled between the mounting arm 106 and its respective first side coulter disc 70 in a manner that allows the coulter disc 70 to rotate relative to the support arm 108 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective tool mount 100 (e.g., the arm assembly 104 of the mount 100). In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

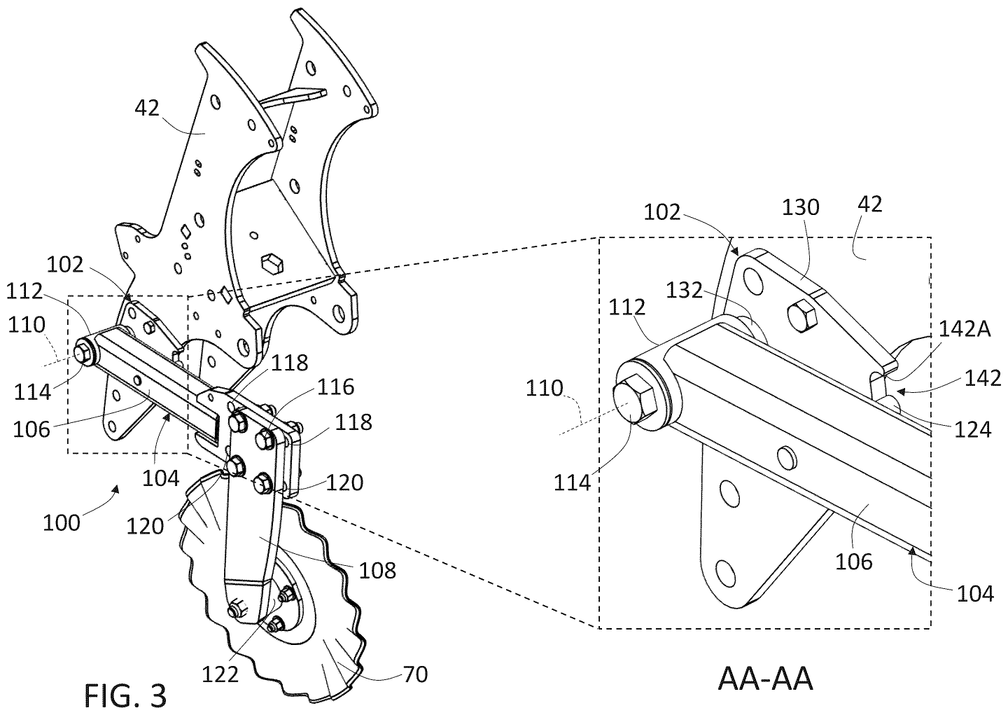

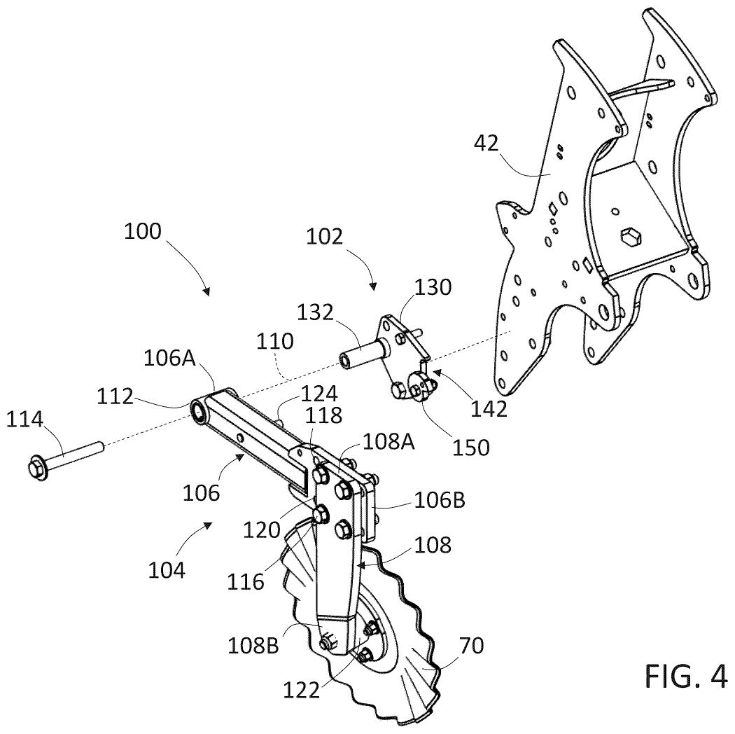

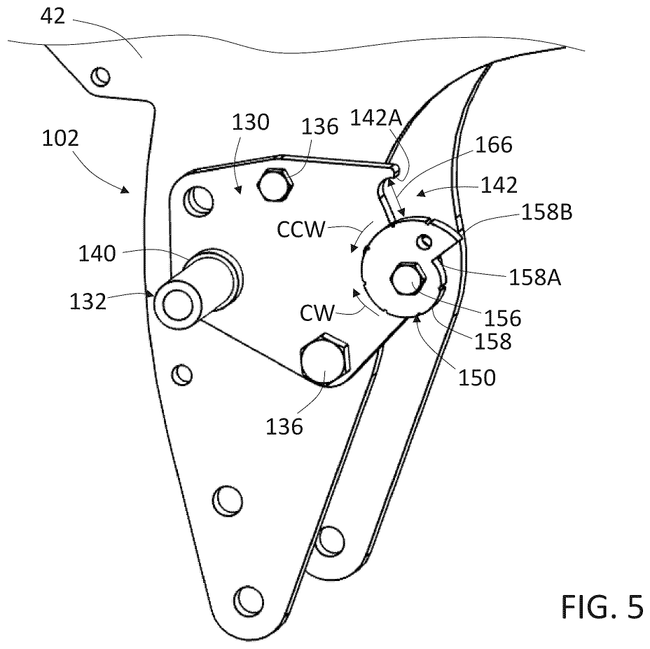

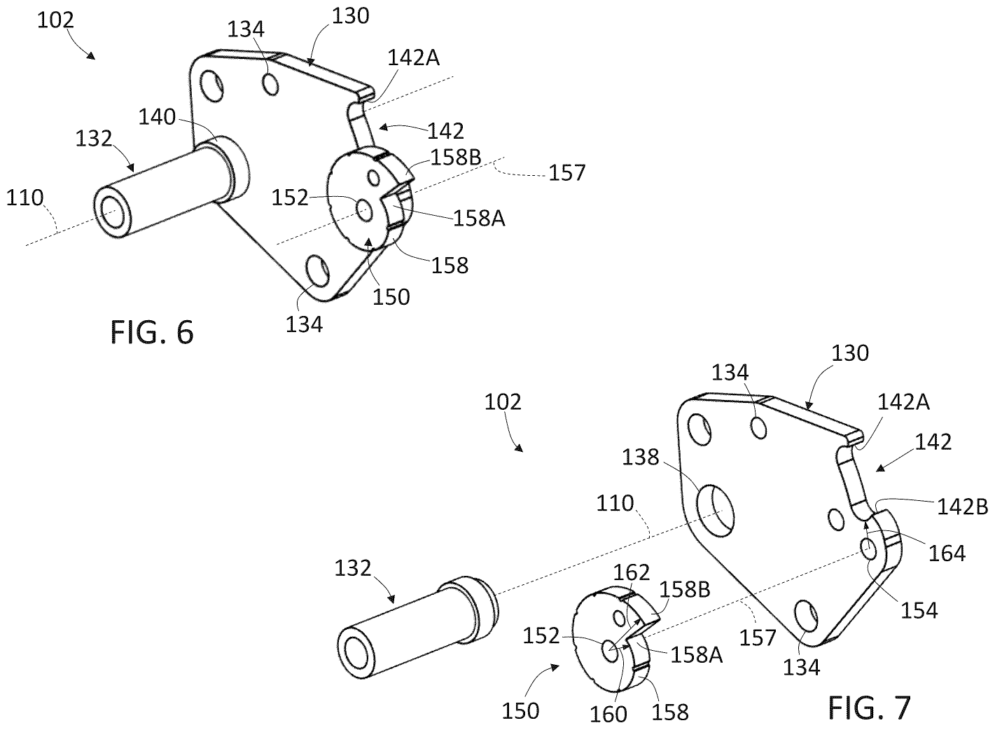

Referring now to FIGS. 3-7, several views of one embodiment of a tool mount 100 suitable for with a row unit of an agricultural implement are illustrated in accordance with aspects of the present subject matter. Specifically, FIG. 3 illustrates a perspective view of the tool mount 100 mounted to a row unit frame (e.g., frame 42 of FIG. 2) of a row unit, particularly illustrating the tool mount 100 supporting a ground-engaging tool (e.g., side coulter 70) relative to the row unit frame. FIG. 3 also illustrates a blown-up or zoomed-in portion of the tool mount 100 shown in box AA-AA. FIG. 4 illustrates a perspective, partially exploded view of the tool mount 100 and row unit frame shown in FIG. 3. FIG. 5 illustrates a perspective view of a mounting plate assembly 102 of the tool mount 100 as installed relative to the row unit frame. Additionally, FIGS. 6 and 7 illustrate assembled and exploded views, respectively, of the mounting plate assembly 102 shown in FIG. 5 with the various fasteners removed for purposes of illustration.

It should be appreciated that, for purposes of discussion, the tool mount 100 will generally be described herein with reference to the row unit 40 described above with reference to FIG. 2. However, in general, the disclosed tool mount 100 may generally be configured for use with any row unit having any suitable row unit configuration. Additionally, although the tool mount 100 will generally be described herein with reference to supporting a coulter (e.g., side coulter 70) relative to the frame of a row unit, the tool mount 100 may generally be configured to support any suitable ground-engaging tool relative to the row unit frame.

As indicated above, the tool mount 100 may include a mounting plate assembly 102 and an arm assembly 104 for supporting a ground-engaging tool (e.g., coulter 72) relative to a row unit frame 42. In general, the mounting plate assembly 102 may be configured to provide suitable structure for pivotably coupling the arm assembly 104 to the row unit frame 42, thereby allowing the arm assembly 104 to pivot relative to the mounting plate assembly 102 (and the row unit frame 42) about a pivot axis 110 (FIGS. 3 and 4) defined therebetween. Such pivoting of the arm assembly 104 about the pivot axis 110 may, in turn, allow the side coulter 70 to raise and lower relative to the soil surface as it encounters rocks or other obstacles within the field. As described, a side coulter actuator 78 (FIG. 2) may be coupled between the row unit frame 42 and the arm assembly 104 to provide a downforce to normally maintain the side coulter 70 at a desired operating depth relative to the soil surface, with the coulter 70 pivoting upwardly about the pivot axis 110 against the downward bias of the actuator 78 as the coulter 70 encounters obstacles within the field.

Referring particularly to FIGS. 3 and 4, as indicated above, the arm assembly 104 may generally include a mounting arm 106 and a support arm 108. As shown in the illustrated embodiment, the mounting arm 106 extends lengthwise between a first end 106A (FIG. 4) and a second end 106B (FIG. 4), with the first end 106A of the mounting arm 106 configured to be pivotably coupled to the mounting plate assembly 102 and the second end 106B of the mounting arm 106 configured to be rigidly coupled to the support arm 108. For instance, a mounting tube 112 may be provided at the first end 106A of the mounting arm 106 for pivotably coupling the mounting arm 106 to the mounting plate assembly 102 about the pivot axis 110. Specifically, as shown in FIGS. 3 and 4, the mounting tube 112 may be configured to be received on a corresponding sleeve 132 of the mounting plate assembly 102 and secured thereto via an associated fastener 114. In such an embodiment, suitable bearings (not shown) may be provided between the mounting tube 112 and the sleeve 132 to allow the mounting arm 106 to pivot relative to the mounting plate assembly 102 about the pivot axis 110. Alternatively, the sleeve 132, itself, may provide a bearing surface about which the mounting tube 112 rotates as the mounting arm 106 pivots relative to the mounting plate assembly 102 about the pivot axis 110.

Additionally, as shown in FIGS. 3 and 4, the support arm 108 may be configured to extend lengthwise between a proximal end 108A (FIG. 4) and a distal end 108B (FIG. 4), with the proximal end 108A configured to be coupled to the second end 106B of the mounting arm 106 and the distal end 108B configured to be coupled to the coulter 70. For instance, as shown in the illustrated embodiment, the proximal end 108A of the support arm 108 may be configured to rigidly coupled to the second end 106B of the mounting arm 106 via a plurality of fasteners 116 to provide a rigid connection between the arms 106, 108 of the arm assembly 104. In such an embodiment, the mounting arm 106 may, in one embodiment, be configured to define a set or array of fastener openings to allow the proximal end 108A of the support arm 108 to be selectively coupled to the mounting arm 106 at a number of different positions spaced apart in the fore-aft direction FA of the row unit 40, thereby allowing the fore-aft positioning of the coulter 70 to be adjusted relative to the remainder of the ground-engaging tools of the row unit 40. For instance, as shown in FIGS. 3 and 4, the second end 106B of the mounting arm 106 may have a plate-like configuration defining a plurality of pairs of first and second fastener openings 118, 120 spaced apart from one another in the fore-aft direction FA to allow the support arm 108 to be selectively coupled to the mounting arm 106 at a plurality of different fore-aft positions.

It should be appreciated that the distal end 108B of the support arm 108 may be configured to be coupled to the coulter 70 in any suitable manner that allows the coulter 70 to be supported by the support arm 108 for rotation relative thereto. For instance, a suitable bearing or hub 122 may be coupled between the distal end 108B of the support arm 108 and the coulter 70 to allow the coulter 70 to rotate relative to the support arm 108 as the coulter 70 engages the ground during the performance of a strip tillage operation.

Referring particularly now to FIGS. 5-7, the mounting plate assembly 102 generally includes a mount plate 130 and a mount sleeve 132. In general, the mount plate 130 may correspond to a plate-like structure or member configured to be rigidly coupled to the row unit frame 42. For instance, as shown in FIGS. 6 and 7, the mount plate 130 may define two or more fastener openings (e.g., a pair of fastener openings 134) configured to receive corresponding fasteners 136 (FIG. 5) for mounting the plate 130 to the row unit frame 42. By defining at least two fastener openings 134, the mount plate 130 may be rigidly coupled to the row unit frame 42 without any rotation of the plate 130 during operation. Moreover, by using fasteners 136 as opposed to welding the mount plate 130 to the frame 42, the mount plate 130 may be removably coupled to the frame 42, thereby allowing it to be replaced as desired.

Additionally, the mount plate 130 may also define a sleeve opening 138 (FIG. 7) configured to receive the mount sleeve 132 of the mounting plate assembly 130. In one embodiment, the mount sleeve 132 may be configured to be inserted within the sleeve opening 138 and welded to the mount plate 130, thereby providing a rigid connection between the sleeve 132 and the plate 130. Alternatively, the mount sleeve 132 may be pressed into the sleeve opening 138 to provide a rigid connection between the sleeve 132 and the plate 130. Regardless, as shown in FIGS. 5-7, the mount sleeve 132 may include an outer stop ring 140 configured to contact the outer surface of the mount plate 130 when the sleeve 132 is fully seated within the sleeve opening 138.

As indicated above, the sleeve 132 may be configured to extend through the associated mounting tube 112 provided at the first end 106A of the mounting arm 106, thereby permitting the arm assembly 104 to be pivotably coupled to the mounting plate assembly 102 for rotation relative thereto about the pivot axis 110. In this regard, as shown in FIGS. 6 and 7, the sleeve 132 may generally be configured to extend lengthwise or axially from the mount plate 130 along the pivot axis 110.

It should be appreciated that, in one embodiment, the sleeve 132 may be configured as a hardened sleeve to provide increased wear resistance at the rotational interface defined between the sleeve 132 and the mounting arm 106. For instance, the sleeve 132 may be undergo a hardening process to increase the material hardness of the sleeve 132.

Referring still to FIGS. 5-7, the mounting plate assembly 102 may also incorporate depth stop features for limiting the pivot range about which the arm assembly 104 is configured to pivot relative to the mounting plate assembly 102 about the pivot axis 110, with the pivot range generally corresponding to a depth range or vertical travel range of the coulter 70 relative to the soil surface. Specifically, in the illustrated embodiment, the mount plate 130 may be configured to define a depth stop channel 142 within which a corresponding stop pin 124 (FIGS. 3 and 4) of the arm assembly 104 is configured to extend. For example, referring briefly back to FIGS. 3 and 4, a stop pin 124 is configured to extend outwardly from the mounting arm 105 such that the stop pin 106 is received within the depth stop channel 142 when the mounting arm 106 is pivotably coupled to the mount sleeve 132. Such receipt of the stop pin 124 within the depth stop channel 142 is particularly shown in the zoomed-in portion AA-AA of FIG. 3.

As particularly shown in FIG. 7, the depth stop channel 142 extends lengthwise between an upper end 142A and a lower end 142B, with the upper end 142A defining an upper limit of the pivot range of the arm assembly 104 and the lower end 142B defining a minimum lower limit of the pivot range of the arm assembly 104. It should be appreciated that, as indicated above, the downforce applied against the arm assembly 104 via the side coulter actuator 78 (FIG. 2) may be configured to bias the arm assembly 104 to the lower limit of its pivot range. In this regard, assuming the desired operating depth of the coulter 70 corresponds to the coulter depth associated with the minimum lower limit of the pivot range defined by the bottom end 142B of the depth stop channel 142, the downward biasing force provided by the side coulter actuator 78 may cause the arm assembly 104 to pivot downwardly relative to the mounting plate assembly 102 about the pivot axis 110 until the stop pin 124 contacts the lower end 142B of the depth stop channel 142, thereby setting the operating depth of the coulter 70. Similarly, as the arm assembly 104 pivots upwardly relative to the mounting plate assembly 102 about the pivot axis 110 as the coulter 70 encounters obstacles within the field, the stop pin 124 will contact the upper end 142A of the depth stop channel 142 to prevent further upward pivoting of the arm assembly 104 relative thereto.

Additionally, as shown in FIGS. 5-7, the mounting plate assembly 102 may also include an adjustable depth stop member 150 configured to be supported by the mount plate 130 relative to the depth stop channel 142 to allow the lower limit of the pivot range of the arm assembly 104 to be adjusted. For example, as shown in FIG. 7, the depth stop member 150 defines a fastener opening 152 configured to be aligned within a corresponding fastener opening 154 defined by the mount plate 130 at a location generally adjacent to the bottom end 142B of the depth stop channel 142. As such, a suitable fastener 156 (FIG. 5) may be inserted though the aligned openings 152, 154 to couple the depth stop member 150 to the mount plate 130 adjacent to the bottom end 142B of the depth stop channel 142.

As particularly shown in FIG. 7, the adjustable depth stop member 150 is configured as a cam shaped member having an outer cam surface 158 that defines a varying radius of curvature around the outer perimeter of the depth stop member 150. For instance, the outer cam surface 158 generally extends circumferentially between a first surface end 158A and a second surface end 158B, with the depth stop member 150 defining a minimum radius 160 (FIG. 7) at or adjacent to the first end 158A of the outer cam surface 158 and a maximum radius 162 (FIG. 7) at or adjacent to the second end 158B of the outer cam surface 158. In such an embodiment, the shape of the depth stop member 150 may be selected such that the radius of the outer cam surface 158 generally increases continuously as the surface 158 extends between its first and second ends 158A, 158B. As a result, by adjusting the rotational position or circumferential orientation of the depth stop member 150 relative to the mount plate 130 (and particularly relative to depth stop channel 142), the lower limit of the pivot range of the arm assembly 104 may be adjusted to vary the maximum depth setting of the coulter 70. Specifically, in one embodiment, the minimum radius 160 defined by the depth stop member 150 may generally be equal to a radial distance 164 (FIG. 7) defined between the center of the fastener opening 156 defined by the plate 130 and the bottom end 142B of the depth stop channel 142. As such, by rotating the depth stop member 150 relative to the mount plate 130 (about pivot axis 157 (FIGS. 6 and 7)) to a position at which the first end 158A of the outer cam surface 158 is generally aligned with the depth stop channel 142, the arm assembly 104 may be configured to pivot relative to the mounting plate assembly 102 about its full pivot range defined between the upper and lower ends 142A, 142B of the depth stop channel 142. However, as the depth stop member 150 is further rotated relative to the mount plate 130 such that a different portion of the outer cam surface 158 is generally aligned with the depth stop channel 142, the pivot range of the arm assembly 104 may shortened or decreased to an adjusted pivot range defined between the upper end 142A of the depth stop channel 142 and the outer cam surface 158 of the depth stop member 150. For instance, as shown in FIG. 5, the depth stop member 150 is oriented relative to the mount plate 130 such that pivot range of the arm assembly 104 is limited to a distance 166 defined between the upper end 142A of the depth stop channel 142 and the outer cam surface 158 of the depth stop member 150. At such circumferential orientation, to increase the pivot range (and, thus, increase the depth setting of the coulter 70), the depth stop member 150 may be rotated relative to the mount plate 130 in a clockwise direction (indicated by arrow CW in FIG. 5) such that the portion of the outer cam surface 158 aligned with the depth stop channel 142 generally defines a smaller radius and, thus, increases the distance 166 defined between the upper end 142A of the depth stop channel 142 and the outer cam surface 158. Similarly, to decrease the pivot range (and, thus, decrease the depth setting of the coulter 70), the depth stop member 150 may be rotated relative to the mount plate 130 in a counterclockwise direction (indicated by arrow CCW in FIG. 5) such that the portion of the outer cam surface 158 aligned with the depth stop channel 142 generally defines a larger radius and, thus, decreases the distance 166 defined between the upper end 142A of the depth stop channel 142 and the outer cam surface 158.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A row unit for an agricultural implement, the row unit comprising:
a row unit frame;
a tool mount configured to support a ground-engaging tool of the row unit relative to the row unit frame, the tool mount comprising:
a mounting plate assembly comprising a mount plate and a mount sleeve, the mount plate configured to be rigidly coupled to the row unit frame and defining a depth stop channel, the mount sleeve extending outwardly from the mount plate along a pivot axis,
an arm assembly coupled between the mounting plate assembly and the ground-engaging tool, the arm assembly comprising a mounting arm pivotably coupled to the mount sleeve such that the arm assembly is configured to pivot relative to the mounting plate assembly about the pivot axis across a pivot range of the arm assembly;
wherein:
the depth stop channel at least partially defines the pivot range for the arm assembly;
the arm assembly includes a stop pin extending outwardly from the mounting arm that is configured to be received within the depth stop channel; and
the stop pin is configured to engage at least one end of the depth stop channel to limit further pivoting of the arm assembly relative to the mounting plate assembly.

2. The row unit of claim 1, wherein the mount sleeve comprises a hardened sleeve.

3. The row unit of claim 1, wherein the mount plate is configured to be removably coupled to the row unit frame.

4. The row unit of claim 3, wherein the mount sleeve is welded to the mount plate to provide a rigid connection between the mount sleeve and the mount plate.

5. The row unit of claim 1, wherein the mounting plate assembly further comprises a depth stop member coupled to the mount plate adjacent to the depth stop channel such that an upper limit of the pivot range of the arm assembly is defined by an end of the depth stop channel and a lower limit of the pivot range of the arm assembly is defined by an outer surface of the depth stop member, the depth stop member being rotatable relative to the plate mount to adjust the lower limit of the pivot range of the arm assembly.

6. The row unit of claim 5, wherein the depth stop member is shaped such that a radius of the outer surface of the depth stop member varies between a first end of the outer surface and a second end of the outer surface.

7. The row unit of claim 1, wherein the arm assembly further comprising a support arm coupled between the mounting arm and the ground-engaging tool, wherein the support is configured to be selectively coupled to mounting arm at one of a plurality of different locations.

8. The row unit of claim 1, wherein the ground-engaging tool comprises a coulter disc.

9. An agricultural implement, comprising:
a frame;
a plurality of row units supported relative to the frame, each of the plurality of row units comprising:
a row unit frame;
a tool mount configured to support a ground-engaging tool of the agricultural implement relative to the row unit frame, the tool mount comprising:
a mounting plate assembly comprising a mount plate and a mount sleeve, the mount plate configured to be rigidly coupled to the row unit frame and defining a depth stop channel, the mount sleeve extending outwardly from the mount plate along a pivot axis,
an arm assembly coupled between the mounting plate assembly and the ground-engaging tool, the arm assembly comprising a mounting arm pivotably coupled to the mount sleeve such that the arm assembly is configured to pivot relative to the mounting plate assembly about the pivot axis across a pivot range of the arm assembly;
wherein:
the depth stop channel at least partially defines the pivot range for the arm assembly;
the arm assembly includes a stop pin extending outwardly from the mounting arm that is configured to be received within the depth stop channel; and
the stop pin is configured to engage at least one end of the depth stop channel to limit further pivoting of the arm assembly relative to the mounting plate assembly.

10. The agricultural implement of claim 9, wherein the mount sleeve comprises a hardened sleeve.

11. The agricultural implement of claim 9, wherein the mount plate is configured to be removably coupled to the row unit frame.

12. The agricultural implement of claim 11, wherein the mount sleeve is welded to the mount plate to provide a rigid connection between the mount sleeve and the mount plate.

13. The agricultural implement of claim 9, wherein the mounting plate assembly further comprises a depth stop member coupled to the mount plate adjacent to the depth stop channel such that an upper limit of the pivot range of the arm assembly is defined by an end of the depth stop channel and a lower limit of the pivot range of the arm assembly is defined by an outer surface of the depth stop member, the depth stop member being rotatable relative to the plate mount to adjust the lower limit of the pivot range of the arm assembly.

14. The agricultural implement of claim 13, wherein the depth stop member is shaped such that a radius of the outer surface of the depth stop member varies between a first end of the outer surface and a second end of the outer surface.

15. The agricultural implement of claim 9, wherein the arm assembly further comprising a support arm coupled between the mounting arm and the ground-engaging tool, wherein the support is configured to be selectively coupled to mounting arm at one of a plurality of different locations.

16. The agricultural implement of claim 9, wherein the ground-engaging tool comprises a coulter disc.

17. A tool mount configured for use with an agricultural implement, the tool mount comprising:
a mounting plate assembly comprising a mount plate and a mount sleeve, the mount plate configured to be rigidly coupled to a frame of the agricultural implement, the mount plate defining a depth stop channel, the mount sleeve comprising a hardened sleeve welded to the mounting plate to provide a rigid connection between the mount sleeve and the mount plate, the mount sleeve extending outwardly from the mount plate along a pivot axis,
an arm assembly configured to support a ground-engaging tool of the agricultural implement relative to the mounting plate assembly, the arm assembly comprising a mounting arm pivotably coupled to the mount sleeve such that the arm assembly is configured to pivot relative to the mounting plate assembly about the pivot axis across a pivot range of the arm assembly;
wherein:
the depth stop channel at least partially defines the pivot range for the arm assembly;
the arm assembly includes a stop pin extending outwardly from the mounting arm that is configured to be received within the depth stop channel; and
the stop pin is configured to engage at least one end of the depth stop channel to limit further pivoting of the arm assembly relative to the mounting plate assembly.

18. The tool mount of claim 17, wherein the mounting plate assembly further comprises a depth stop member coupled to the mount plate adjacent to the depth stop channel such that an upper limit of the pivot range of the arm assembly is defined by an end of the depth stop channel and a lower limit of the pivot range of the arm assembly is defined by an outer surface of the depth stop member, the depth stop member being rotatable relative to the plate mount to adjust the lower limit of the pivot range of the arm assembly.

19. The tool mount of claim 18, wherein the depth stop member is shaped such that a radius of the outer surface of the depth stop member varies between a first end of the outer surface and a second end of the outer surface.

20. The tool mount of claim 17, wherein the arm assembly further comprising a support arm coupled between the mounting arm and the ground-engaging tool, wherein the support is configured to be selectively coupled to mounting arm at one of a plurality of different locations.
